(19) United States
(12) Patent Application Publication
(10) Pub. No.: US 2003/0071877 A1
(43) Pub. Date: Apr. 17, 2003

(54) Deposition method for a passivation layer of a fluid ejection device

(76) Inventor: Ulrich E. Hess, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/978,985

(22) Filed: Oct. 16, 2001

(51) Int. Cl. B41J 2/05

(52) U.S. Cl. 347/64

(57) ABSTRACT

In one embodiment of the present invention, a passivation layer of a fluid ejection device is formed by an atomic layer epitaxy process.

### CROSS REFERENCE TO RELATED APPLICATION

The present disclosure may contain subject matter that is related to commonly assigned U.S. patent application Ser. No. 09/296,940, filed Apr. 22, 1999, titled “Inkjet Printhead and Method of Producing Same”.

### BACKGROUND OF THE INVENTION

Commercial products such as computer printers, graphics plotters, and facsimile machines have been implemented with fluid ejection devices producing printed media. In many cases, such devices utilize inkjet technology whereby an inkjet image is created when a precise pattern of dots is formed on a printing medium from ejected ink droplets. Typically, an inkjet printhead is supported on a movable carriage that traverses over the surface of the print medium and is controlled to eject drops of ink at appropriate times pursuant to command of a microcomputer or other controller, wherein the timing of the application of the ink drops is intended to correspond to a pattern of pixels of the image being printed.

A typical inkjet printhead includes an array of precisely formed nozzles in an orifice plate. The plate is attached to a thin film substrate that implements ink firing heater resistors and apparatus for enabling the resistors. The thin film substrate is generally comprised of several thin layers of insulating, conducting or semiconductor material that are deposited successively on a supporting substrate, or die, in precise patterns to form collectively, all or part of an integrated circuit.

The thin film substrate or die is typically comprised of a layer such as silicon on which are formed various thin film layers that form thin film ink firing resistors, apparatus for enabling the resistors, and interconnections to bonding pads that are provided for external electrical connections to the printhead. Ongoing improvements in the design of fluid ejection devices have resulted in more efficient printhead components, such as resistors and passivation layers. In some cases, passivations deposited by physical vapor deposition or chemical vapor deposition methods have been utilized to improve performance. In other cases, sputtering techniques have been used to achieve passivation. While these techniques have some utility, it is desirable to have an improved passivation technique capable of improving performance and increasing resistor life.

Of course, energy expenditure is necessary for operation of fluid ejection devices. In this regard, the term “turn on energy” relates to the energy required to form a vapor bubble of a size sufficient to eject a predetermined amount of ink volume through a printhead nozzle. With ever increasing usage of electrically driven devices, conservation becomes an important consideration. With respect to fluid ejection devices, a reduction in turn on energy would be desirable, especially if such reduction produced improved printhead performance and prolonged printhead life.

### SUMMARY

In one embodiment of the present invention, a passivation layer of a fluid ejection device is formed by an Atomic Layer Epitaxy (ALE) process.

Other aspects and advantages of the present invention will become apparent from the following detailed description, taken in conjunction with the accompanying drawings, illustrating by way of example the principles of the invention.

### BRIEF DESCRIPTION OF DRAWINGS

FIG. 1 is an unscaled cross sectional view of a portion of a fluid ejection device showing a dual metal contact technique utilizing a thin dielectric film formed by an ALE technique in one embodiment of the present invention; and

FIG. 2 is an unscaled cross sectional view of a portion of a fluid ejection device showing a single metal contact technique utilizing a thin dielectric film formed by an ALE technique in another embodiment of the present invention.

### DETAILED DESCRIPTION

In one embodiment of the present invention, a very thin passivation layer, of predetermined thickness, can be achieved by utilization of an ALE process of film deposition. The ALE process is a process whereby chemical vapor deposition of a selected composition is deposited on a substrate one molecular layer at a time.

In one particular embodiment, the passivation layer referred to is a thin dielectric film formed on the surface of a substrate. The passivation layer generally protects exposed elements of a fluid ejection device from environmental contaminants, thus ensuring electrical stability of the printhead. The layer deposited using the ALE process is referred to herein as, for example, an ALE dielectric or an ALE passivation layer, as appropriate.

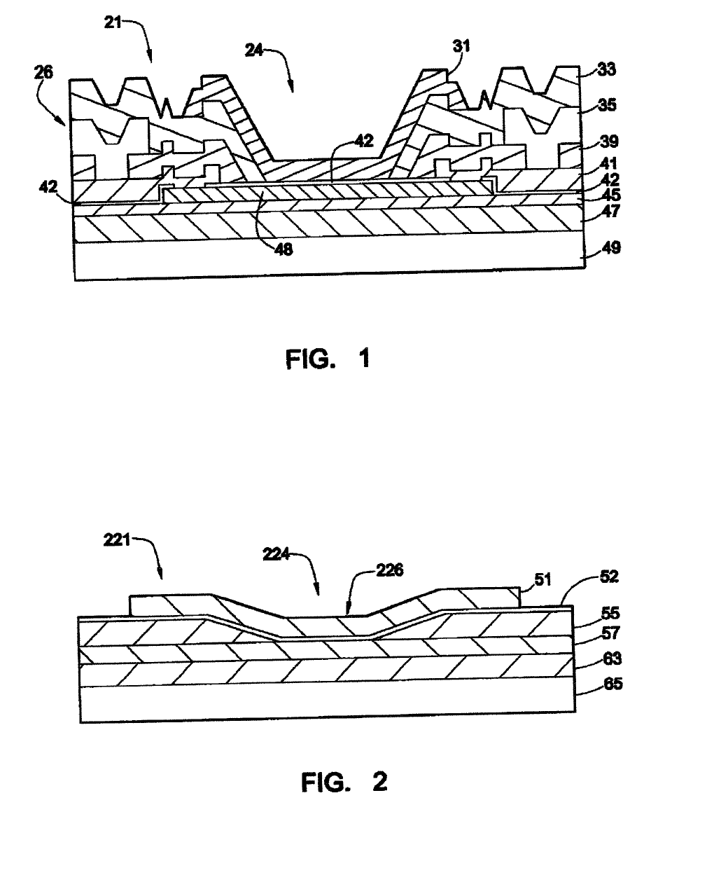

Referring now to the drawings, one particular embodiment of a fluid ejection device is described with regard to FIG. 1. Another particular embodiment of a fluid ejection device is described with regard to FIG. 2. In the following description, numbers in parentheses represent one embodiment of approximate film/substrate thickness, expressed in micrometers. In the embodiment of FIG. 1, an unscaled cross sectional view of a portion of a fluid ejection device (or printhead) 21 having an ALE dielectric or passivation layer 42 is shown. The fluid ejection device 21 is comprised of a plurality of thin film layers, generally indicated by the reference numeral 26, that are stacked atop a die 49. Contact termination in the printhead is also shown in FIG. 1, as described in more detail below.

The layers over the die form thin film ink firing resistors or heating elements such as the resistor 48, and an apparatus for enabling the resistors. In a particular embodiment, the die 49 (650) is composed of silicon. The silicon die 49 is a semiconductor that functions as a substrate to support the overlying layers. In this regard, immediately overlying the die 49 there is formed a field oxide (FOX) or tetra ethyl ortho silicate (TEOS) (1.0) layer 47. This layer insulates the overlying ink-jet circuitry from the silicon die 49 and provides thermal isolation from the silicon, thereby keeping the circuitry above the layer 47 from being shorted out by the silicon below. In operation, the layer 47 functions as a standoff so that heat moves away from, rather than toward, the silicon die 49.

A silicon nitride (Si3N4) (0.1) film 45, formed by low pressure chemical vapor deposition, is deposited upon the layer 47. The layer 45 chemically stabilizes the underlying FOX/TEOS layer 47 and provides thermal and chemical stabilization of the heating element or layer 48. This layer is patterned on the layer 45 and is chemically defined by an etching process. The element 48 is comprised of resistive materials such as tantalum, aluminum, silicon or tantalum nitride and it functions to heat resistively the overlying structure to enable ejection of an ink droplet.

The overlying structure includes an ALE passivation layer 42 that is deposited, patterned and etched to open up contact holes at end of the resistor 48. In this regard, the ALE layer 42 is structured to create interconnects to a layer 41 (0.5). In one embodiment, the layer 41 is a thin tungsten film (0.5) deposited and patterned by plasma processes. Overlying the tungsten layer 41 is a TEOS layer (0.6) 39 that is disposed laterally in relation to the firing chamber 24. The layer 39 is etched to enable an overlying aluminum contact terminal 35 to contact the tungsten layer 41. In this manner, the layer 39 functions as an interdielectric between two metals, the underlying tungsten layer 41 and the overlying aluminum contact terminal 35.

In the embodiment shown in FIG. 1, the firing chamber 24 includes a cavitation barrier layer or a tantalum layer (0.3) 31 deposited over the stack 26 and in contact laterally with a tetra ethyl ortho silicate (TEOS) layer (0.6) 33. The tantalum layer 31 provides mechanical protection to the underlying structure and, in particular, prevents chemical and impact damage to the resistor 48. The TEOS layer 33, on the other hand, provides insulation for the layers of the fluid ejection device and separates the tantalum layer 31 from other structures. It will be noted that the tantalum layer 31 is isolated throughout the ejection device 21, except where it contacts the ALE layer 42.

The ALE layer 42 is now considered in greater detail. In a preferred embodiment, the ALE layer 42 is a dielectric film, particularly aluminum oxide. The film is very thin, typically having a thickness of between about 250 Å and 2000 Å, preferably about 1000 Å. This thin film enables substantially reduced drive energies because of the thinness of the dielectric and, possibly, because of enhanced thermal conductivity. Dielectrics that can be deposited by the ALE technique contain refractory metals, transitional metals and insulators, such as silicates. Other dielectrics include metal oxides, nitrides, borides and carbides.

During the ALE process, aluminum source gas and oxygen source gas are employed alternately with inert purge gasses in between. The purge gasses ensure that no stray gasses, such as the aluminum source, are present before the next gas, such as the oxygen source, is employed. The deposited aluminum from the aluminum source chemically reacts with the deposited oxygen from the oxygen source to form aluminum oxide. The layers of the aluminum oxide build up molecular layer by molecular layer using this process. As a result of the build up monolayer by monolayer, the final thickness of the layer is well controlled.

In an alternative embodiment, as shown in FIG. 2, the resistor film and the conductive film are deposited before the ALE process. The figure is an unscaled cross sectional view of another embodiment of a fluid ejection device 221. The device 221 is comprised of a plurality of thin film layers, generally indicated by the reference numeral 226. The device 221 utilizes ALE dielectric, and utilizes contact termination as described above in reference to the ejection device 21. The fluid ejection device 221 includes a firing chamber 224. In addition, the fluid ejection device 221, like the device 21 of FIG. 1, is comprised of a plurality of thin film layers stacked on a silicon die 65.

The die 65 is similar in structure and function to the die 49 of FIG. 1. A field oxide or TEOS layer (1.0) 63, similar in structure and function to the layer 47 of FIG. 1, is disposed on the die 65 and a heating (or resistor) layer 57, composed of tantalum/aluminum, or other suitable metal, is disposed on the layer 63. An aluminum layer (0.5) 55 is disposed laterally of the region 226 and overlying the layer 57. The aluminum layer 55 is covered by an ALE dielectric (0.1) film 52. The ALE film 52 is similar to the layer 42 of FIG. 1 and is formed according to the above described process.

The present invention affords several distinct advantages. Because it is so thin, the dielectric permits reduced drive energies with consequent low turn on energy drop generation of the resistor, for example, in the resistor regions of the ejection devices 24 and 224. This, in turn, results in faster thermal response, thereby enabling a higher frequency of operation. The present invention enables rapid printhead resistor heating and cool down. As a result, a thermally more efficient printhead is achieved, with resulting swath size increases. Such increases, in turn, substantially improve fluid ejection device throughput.

In another embodiment, the invention affords the flexibility of using very thin multiple dielectrics for custom tailoring of thermal properties. Because the ALE process enables addition of a layer at a time, a dielectric film having a precise predetermined thickness can be achieved.

Also, because of the low film thickness, the present invention reduces manufacturing costs. This is accomplished as a result of decreased manufacturing cycle time and it is achieved without requiring any substantial printhead redesign.

Advantageously, stresses in the thin films produced by the ALE technique are very low. This factor enhances resistor life.

Because the chemical purity and stoichiometry are very high, resistor printing and storage life are substantially extended. The high thermal efficiency of the present invention translates into comparatively lower steady state die temperatures and enhanced resistor life.

It is known by those skilled in the art that electrical shorts reduce yield in some fluid ejection devices. In the embodiments described above, high particle tolerance in passivation is achieved. Thus, the likelihood of shorts is diminished thereby raising circuit yield.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A passivation layer of a printhead formed by an atomic layer epitaxy process.

2. The passivation layer of claim 2 wherein a material for the passivation contains at least one of refractory metals, transitional metals, insulators, metal oxides, nitrides, borides, and carbides.

3. A fluid ejection device comprising:
a die having a plurality of layers formed thereover;
a firing chamber formed from the plurality of layers, from which heated fluid is ejected,
wherein one of the plurality of layers is an ALE layer that is formed by an atomic layer epitaxy process.

4. The fluid ejection device of claim 3 wherein the ALE layer is a dielectric layer.

5. The fluid ejection device of claim 3 wherein the ALE layer is a passivation layer.

6. The fluid ejection device of claim 3 wherein the plurality of layers include a conductive layer, wherein the ALE layer is formed in between the conductive layer and the firing chamber.

7. The fluid ejection device of claim 3 wherein the ALE layer contains at least one of refractory metals, transitional metals, insulators, metal oxides, nitrides, borides, and carbides.

8. The fluid ejection device of claim 3 wherein the ALE layer is aluminum oxide.

9. The fluid ejection device of claim 3 wherein the ALE layer has a thickness of between about 250 Angstrom units and about 2000 Angstrom units.

10. The fluid ejection device of claim 3 wherein the ALE layer has a thickness of about 1000 Angstrom units.

11. A printhead comprising:
a die;
a firing chamber disposed upon the die;
a heating element interposed between said die and said firing chamber; and
an ALE layer interposed between said heating element and said firing chamber, wherein said ALE layer has a thickness of less than 2000 Angstroms.

12. The fluid ejection device of claim 11 wherein the ALE layer has a thickness of 1000 Angstroms.

13. A fluid ejection device comprising:
a die;
a firing chamber disposed upon the die;
a heating element interposed between said die and said firing chamber; and
a dielectric film, interposed between said heating element and said firing chamber, wherein said dielectric film is formed by an atomic layer epitaxy process.

14. The fluid ejection device according to claim 13, wherein said dielectric film contains at least one of refractory metals, transitional metals, insulators, metal oxides, nitrides, borides, and carbides.

15. The fluid ejection device according to claim 13, wherein said dielectric film is selected from the group having a composition consisting of silicon carbides, silicon nitrides, metal oxides, nitrides, borides, and carbides.

16. The fluid ejection device according to claim 13, wherein said dielectric film is aluminum oxide.

17. The fluid ejection device according to claim 13, wherein said dielectric film has a thickness of between about 250 Angstrom units and about 2000 Angstrom units.

18. The fluid ejection device according to claim 13, wherein said dielectric film has a thickness of about 1000 Angstrom units.

19. A method of forming a passivation layer of a printhead comprising utilizing an atomic layer epitaxy process.

20. The method of claim 19 wherein a material for the passivation layer contains at least one of refractory metals, transitional metals, insulators, metal oxides, nitrides, borides, and carbides.

21. A method of fabricating a fluid ejection device comprising:
utilizing an atomic layer epitaxy process to deposit a layer between a substrate and a firing chamber.

22. The method of claim 21 wherein the layer is deposited to a predetermined thickness.

23. The method according to claim 22, wherein the thickness of the layer is between about 250 Angstrom units and about 2000 Angstrom units.

24. A method of manufacturing a printhead comprising:
forming a plurality of layers over a substrate;
utilizing an atomic layer epitaxy process to form a thin dielectric film over the plurality of layers; and
forming a firing chamber, that ejects fluid therefrom, over the thin dielectric film.

25. The method according to claim 24, wherein the dielectric film contains at least one of refractory metals, transitional metals, insulators, metal oxides, nitrides, borides, and carbides.

26. The method according to claim 24, wherein aluminum oxide is selected as the dielectric film.

27. The method according to claim 24, wherein the plurality of layers includes a heating element, wherein the film is disposed between the heating element and the firing chamber.

28. The method according to claim 24, wherein said film has a thickness of between about 250 Angstrom units and about 2000 Angstrom units.

29. The method according to claim 24, wherein said dielectric film has a thickness of about 1000 Angstrom units.
